(19) United States
(12) Patent Application Publication
(10) Pub. No.: US 2015/0293884 A1
(43) Pub. Date: Oct. 15, 2015

(54) METHOD TO COMPUTE THE BARYCENTER OF A SET OF HISTOGRAMS

(71) Applicant: KYOTO UNIVERSITY, Kyoto-shi (JP)

(72) Inventor: Marco CUTURI CAMETO, Kyoto-shi (JP)

(21) Appl. No.: 14/685,801

(22) Filed: Apr. 14, 2015

(30) Foreign Application Priority Data
Apr. 14, 2014 (JP) 2014-082611

(51) Int. Cl. G06F 17/16

(52) U.S. Cl. CPC G06F 17/16

(57) ABSTRACT

The object of the present invention is to provide novel methods to carry out clustering in huge datasets using generalized formulations. We propose (1) an efficient and novel method to compute the barycenter (or mean) of a set of histograms under the optimal transport distance; (2) as an extension of the first method, an efficient and novel method to cluster data sets of vectors R^{d} with constraints on the clusters' size.

### TECHNICAL FIELD

The present invention relates to a method to compute the barycenter of a set of histograms, in particular, to compute Wasserstein barycenters of N histograms, aggregate approximate dual and primal optimal variables, and Wasserstein barycenters of empirical measures.

### BACKGROUND ART

Simplifying and summarizing efficiently very large datasets is a fundamental task in data analysis algorithms. Two powerful tools to carry out such a task are routinely used as pre-processing steps: the computation of the mean of a dataset, and the computation of multiple means for that dataset, known as the k-means problem, where k is an integer larger than one.

### Mean of a Dataset

An elementary summary of the characteristics of a dataset is given by the mean of that dataset. The mean of a dataset is a point that minimizes the sum of its distances to all the points in the dataset. If we consider for instance a set X={x₁, x₂, . . . , x_{N}} of N points taken in an arbitrary set Ω, an integer p≧1, and consider a distance function dist that can compare two objects in Ω, the mean of X is the object y in Ω which minimizes the quantity:

$${min}_{y ∈ Ω} \frac{1}{n} {\sum }_{i = 1}^{n} d i s {t ( {x}_{i} , y )}^{p}$$

If the points in the dataset are vectors in a vector: space R^{d} of d dimensions, if the Euclidean distance between these vectors is considered, and if the exponent p=2, then their mean in R^{d} is simply the point whose coordinates are each the average of all the coordinates of the points in that dataset, namely:

$$mean ( X ) = \frac{1}{n} {\sum }_{i = 1}^{n} {x}_{i}$$

k-Means of a Dataset

A natural extension of the concept of a single mean is to summarize the dataset using not only one mean element, but many mean elements. Given an integer k≧1, finding such a representation with exactly k means is known as the k-means problem. Given a dataset, of N points {x₁, x₂, . . . , x_{N}} each in Ω, the standard k-means algorithms seeks to find k means points {y₁, y₂, . . . , yₖ} in Ω that minimize the following criterion:

$${min}_{\begin{matrix}( {y}_{1} , … , {y}_{k} ) ∈ {Ω}^{k} \\ σ ∈ {\{ 1 , … , k \}}^{n}\end{matrix}} \frac{1}{n} {\sum }_{i = 1}^{n} {dist ( {x}_{i} , {y}_{{σ}_{i}} )}^{p}$$

These k means are also called centroids. Each of the k centroids {y₁, y₂, . . . , yₖ} is a point in Ω. Finding the best k centroids is the problem of finding the centroids which minimize the average residual error between each point x₁ and its closest neighbor in the set {y₁, y₂, . . . , yₖ}. The vector σ of size N taking values in (1, . . . , k) which appears in the optimization problem is called the attribution vector. The i-th value of that vector, σᵢ, indicates which of the k centroids point x₁ should be attributed to.

FIG. 1 (a) is an illustration of an original dataset, and FIGS. 1(b) to 1(d) are the computations of a single mean, and k-means for k=2, 3. In this example, Ω=R², the distance function is the Euclidean distance and p=2. Crosses in FIGS. 1 (a) to 1(d) stand for points in the plane R². The square in FIG. 1 (b) stands for the usual mean of these crosses. The two squares in FIG. 1 (c) represent the result of a k-means clustering when k is set to 2. The three squares in FIG. 1(d) represent the result of k-means clustering when k is set to 3. Computing the first square in FIG. 1(b) is trivial, and only involves summing the coordinates of all points before dividing them by the number of points. Computing k-means when k>1 is known to be a NP-hard problem.

Given that context, the disclosed system proposes two algorithmic solutions to carry out clustering in challenging yet useful settings: our first method computes the single mean of a set of histograms under the optimal transport metric. As an extension of our first method, we propose a second method to compute a solution to the k-means algorithm when additional constraints are considered on the cluster's sizes, or, equivalently, on the attribution vector.

Fast Computation of Means for Histograms Under the Optimal Transport Distance

The first method can compute the mean of a set of histograms using as a distance function dist the optimal transport distance (also known as the Wasserstein distance). Such a mean is known in the literature as a Wasserstein barycenter. Although computing the single mean of a set of vectors is a trivial task, as shown in FIG. (b), we consider here the challenging case in which each of the observations—the crosses in FIG. 1(b)—are not simple vectors in a Euclidean space, but instead histograms. Additionally, we consider the case where the distance function dist is the optimal transport distance between histograms parameterized by a suitable metric matrix M. The difference between the standard Euclidean mean and the mean induced by the optimal transport metric is illustrated in FIGS. 2 and 3, in which we compute the Wasserstein barycenter (as well as other barycenters that use a different distance) for a set of 30 images represented each as a histogram of intensities in each of the 100×100=10,000 possible pixel locations in the image.

In particular, FIG. 2 illustrates 30 images of nested ellipses. FIGS. 3(a) to 3(d) are illustrations of different means for 30 images of FIG. 2 using different metrics and preprocessing approaches. FIG. 3(a) is an illustration of Euclidean distance, usual arithmetic mean. Although computing the single mean of a set of vectors is a trivial task, as shown in FIG. 3(a), we consider here the challenging case in which each of the observations—the crosses in FIG. 3(a)—are not simple vectors in a Euclidean space, but instead histograms. FIG. 3(b) is an illustration of Euclidean distance after centering each image, FIG. 3(c) is an illustration of Jeffrey centroids, and FIG. 3(d) is an illustration of RKHS mean. The metric parameter used in that setting is the standard Euclidean metric between pixels of the 100×100 pixel grid.

Constrained k-Means Clustering

The second problem we consider is a generalization of k-means clustering which can consider constraints on the total mass carried out by each cluster. In practice, the results of a k-means algorithm can be unbalanced in the sense that the attribution vector σ takes an unbalanced distribution of values: for instance, one might imagine a result of the k-means algorithm where most of the points could be attributed to only one of the k centroids, and the remaining k−1 centroids would only be used for a few remaining points. This situation is for instance observed in FIG. 1(d), where only 3 points are attributed to the smallest centroid, whereas 25 points in the original dataset of FIG. 1(a) are attributed to the largest centroid.

FIG. 4 is an illustration of distribution of average income in the 48 contiguous states of the USA. Each of the 57,647 crosses represents a data point in the dataset. The size (and intensity) of the cross is proportional to the value of the average income observed in that location (lighter crosses indicate higher income). As shown in FIG. 5, results of the standard k-means clustering (here k=48) depicted using downward triangles.

### Mathematical Definitions

### Histograms

Vectors u that have an arbitrary dimension d, and have non-negative coordinates which sum to 1. The set of histograms Σ_{d} of dimension d is defined as follows.

$${Σ}_{d} {=}^{def} \{ u ∈ {R}_{\_}^{d} \vert {\sum }_{i = 1}^{d} {u}_{i} = 1 \} .$$

The drawing in FIG. 6 proposes an illustration of the set Σ₃ of histograms with 3 components, along with two example vectors r and c. Vectors r and c are in Σ₃ since their sum is equal to 1 and they have non-negative components.

$$r = [ \begin{matrix}.2 \\ .2 \\ .6\end{matrix} ] , c = [ \begin{matrix}.4 \\ .1 \\ .5\end{matrix} ] ,$$

### Weighted Point Clouds

A family of a finite number n of points in a space Ω, to each of which is associated a non-negative weight such that the sum of all weights is equal to 1, namely:

P(Ω)={{(u₁, I₁),(u₂, I₂), . . . , (u_{η}, I_{η})}, u∈Σ_{η}, (I₁, . . . , I_{η})∈Ω}
a weighted point cloud is also frequently represented: as a probability measure using the Dirac notation δₓ, which represents a probability measure with mass 1 on the set {x} and 0 elsewhere. For instance, the point cloud

μ={(α₁, y₁), . . . , (α_{η}, y_{η})}
can be represented equivalently in measure notation as:

$$μ = {\sum }_{i = 1}^{n} {α}_{i} {δ}_{{y}_{i}}$$

### Optimal Transport Distance for Histograms

Given two histograms r in Σₙ and c in Σₘ, a cost matrix M=[mₙ] with n lines and m columns, the optimal transport distance (or Wasserstein distance) d_{M} between r and c is defined as the result of the following linear program, with a variable T=[tᵢⱼ]_{y}, which is a n lines m columns matrix of nonnegative entries,

$$\begin{matrix}{d}_{M} ( r , c ) = & minimize & {\sum }_{i = 1 , j = 1}^{n , m} {m}_{ij} {t}_{ij} \\ & subject to & {\sum }_{j = 1}^{m} {t}_{ij} = {r}_{i} , 1 \leq i \leq n \\ & & {\sum }_{i = 1}^{n} {t}_{ij} = {c}_{j} , 1 \leq j \leq m \\ & & {t}_{ij} \geq 0 , i \leq n , j \leq m .\end{matrix}$$

To simplify the expression of the objective above, we will also use for any two matrices of the same size the notation:

$$〈 M . T 〉 := {\sum }_{i = 1 , j = 1}^{n , m} {m}_{ij} {t}_{ij}$$

2-Wasserstein Distance for Weighted Point Clouds in Ω
Given two weighted point clouds μ, ν,

$$μ = {\sum }_{i = 1}^{n} {α}_{i} {δ}_{{y}_{i}} , v = {\sum }_{j = 1}^{m} {b}_{j} {δ}_{{x}_{j}} .$$

and a number p larger than 1, the Wasserstein distance Wₚ(μ, ν) between μ and ν can be directly defined through the formula given above for histograms as

Wₚ(μ, ν)=(d_{M}_{_{XY}}^{p} (α,b))^{1/p},
in which the n-rows and m-columns matrix M^{p}_{XY} is given by the distances between the points described in X and Y,

M_{YX}^{p}=[dist(yᵢ, xⱼ)^{p}]ᵢⱼ

### Wasserstein Barycenter of Histograms

Given a family {c¹, c², . . . , c^{N}} of histograms in the simplex Σₙ of n variables, and a matrix M with n lines and columns that accounts for the pairwise distances between all n bins of each histogram, the problem of computing the Wasserstein barycenter of these histograms is that of finding the histogram r which minimizes

$${min}_{r ∈ {Σ}_{n}} \frac{1}{N} {\sum }_{i = 1}^{N} {d}_{M} ( r , {c}^{i} )$$

Note that this definition agrees with the general definition we provided in Embodiment 1 for any arbitrary distance function.

### Previous Work

### Computation of Wasserstein Barycenters for Histograms

Agueh and Cartier (2011) introduced first the framework of Wasserstein barycenters for arbitrary probability measures and described some of their theoretical properties. (Non-Patent Literature 1). They did not, however, propose a practical approach to compute them on point-clouds, histograms or empirical measures. Rabin et al. (2012) more recently proposed an algorithmic approach based on minimizing an approximation of the Wasserstein distance, that they term the sliced Wasserstein distance (Non-Patent Literature 2). Their method assumes that the distance is Euclidean, and that the set Ω is a Euclidean space of low dimension. Our method does without these restrictions, and can thus be applied to histograms representing structured datatypes, such as bags-of-words or bags-of-visual-features.

Generalized k-Means with Arbitrary Constraints on Clusters' Sizes

k-means clustering with no constraints on cluster size was proposed by Lloyd as early as the early 50's, but only published for the general public in 1982 (Non-Patent Literature 3). Ng (2000) proposed to study the k-means problem with uniform constraints on the weights (No Patent Literature 4), as we have illustrated in FIG. 4. Ng's algorithmic approach relies on the explicit computation of optimal transports, winch are computationally intensive, and can only be applied to the case where the weights are uniquely fixed.

### CITATION LIST

### Non-Patent Literature

Non-Patent Literature 1: Agueh, M., Cartier, G., “Barycenters in the Wasserstein space”, SIAM Journal on Mathematical Analysis, 2011, 43(2), pp. 904-924. Non-Patent Literature 2: Rabin, J., Peyré, G., Delon, J., & Bernot, M., “Wasserstein barycenter and its application to texture mixing”, Scale Space and Variational Methods in Computer Vision, Springer Berlin Heidelberg, 2012, pp. 435-446.
Non-Patent Literature 3: Lloyd, Stuart P., “Least squares quantization in PCM”, IEEE Transactions on Information Theory, 1982, 28 (2), pp. 129-137.
Non-Patent Literature 4: Ng, M. K., “A note on constrained k-means algorithms”, Pattern Recognition, 2000, 33(3), pp. 515-519.

### SUMMARY OF INVENTION

### Technical Problem

The present invention has been made in consideration of the problems described above, and has as its object to provide an optimization apparatus for easily computing the mean element of histograms and, as an extension, proposing an algorithm to carry out clustering with convex constraints on the weights of each cluster.

### Solution to Problem

To address the problems, we propose the methods of the claims, i.e. a general approach of smoothing optimal transport distances with a regularization term to solve variational problems involving optimal transport distances, as well as Algorithms 1 to 3 described below.

### Advantageous Effects of Invention

According to these methods, it is possible to easily compute the barycenter (or mean) of a set of histograms under the optimal transport distance, and to cluster data sets of vectors in R^{d} with constraints on the clusters' size.

### BRIEF DESCRIPTION OF DRAWINGS

FIG. 1(a) shows an illustration of an original dataset, and FIGS. 1(b) to 1(d) are the computations of a single mean, and k-means for k=2,3.

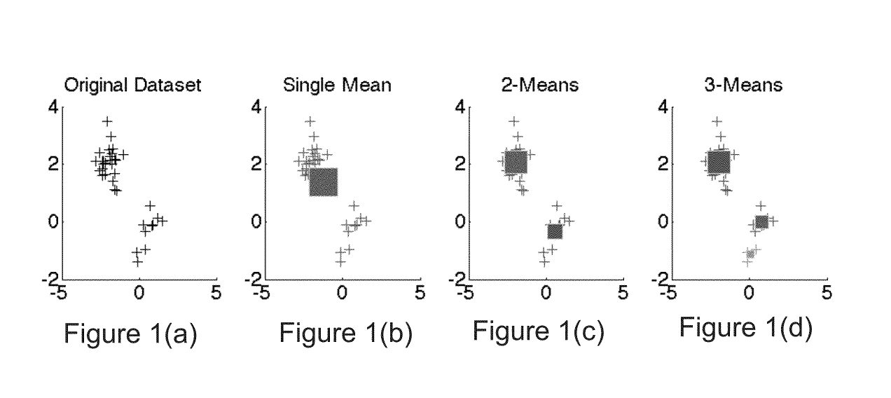

FIG. 2 shows an illustration of 30 images of nested ellipses, and each image is a 100×100 pixel image where the total intensity of the pixels has been normalized to sum to 1.

FIG. 3 (a) to (d) show illustrations of different means for the 30 images of FIG. 2 using different metrics and preprocessing approaches, (a) is an illustration of Euclidean distance, usual arithmetic mean, (b) is an illustration of Euclidean distance after centering each image, (c) is an illustration of Jeffrey centroids, and (d) is an illustration of RKHS mean.

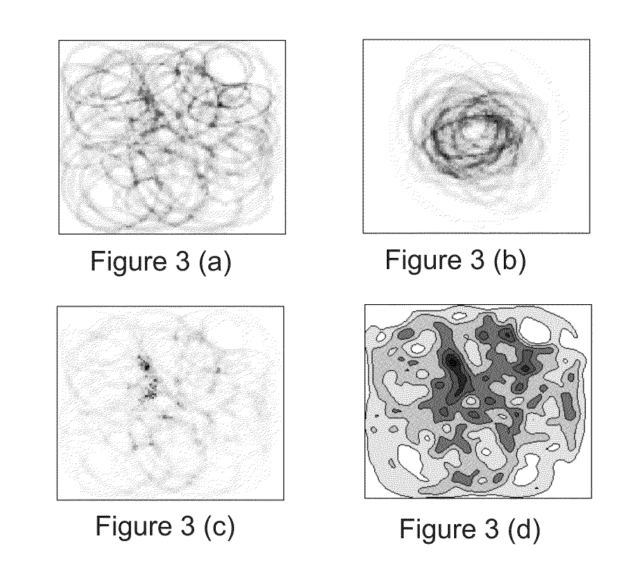

FIG. 4 shows an illustration of the distribution of average income in the 48 contiguous states of the USA.

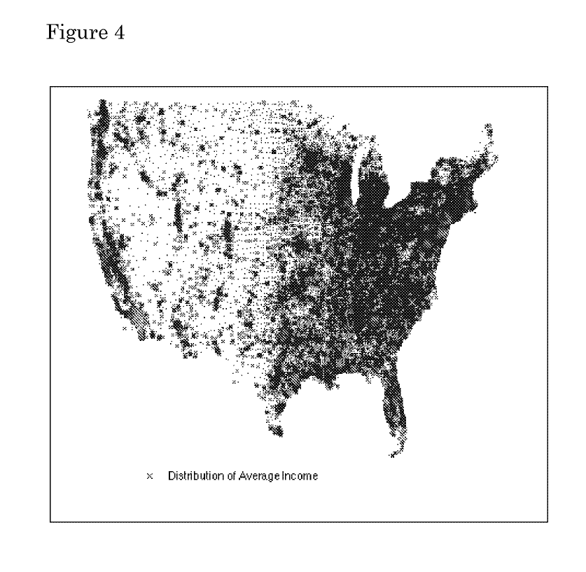

FIG. 5 shows results of the standard k-means clustering (here k=48) depicted using downward triangles.

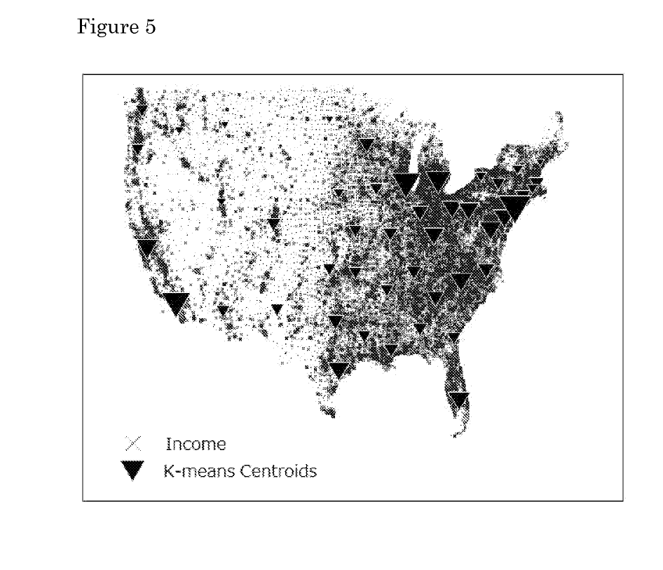

FIG. 6 shows the set of histograms Σ_{d} for d=3.

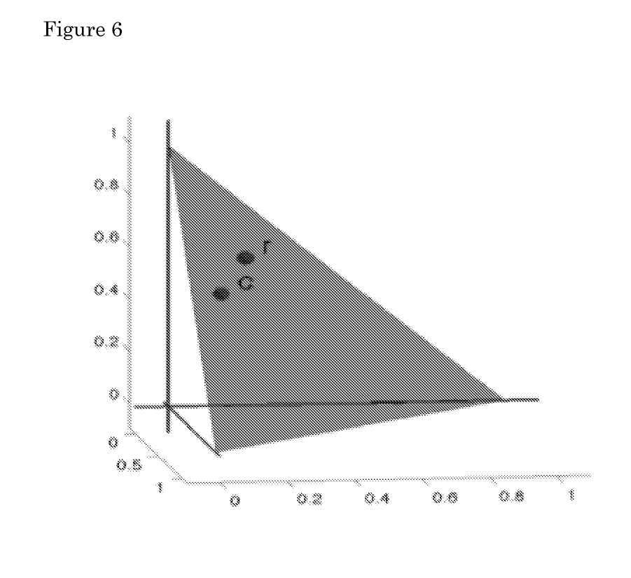

FIG. 7 shows the mean for the 30 images of FIG. 2 using the metrics and preprocessing approaches of the present invention.

FIG. 8 shows results of the clustering method of the present invention depicted using discs.

### DESCRIPTION OF EMBODIMENTS

The invention is composed of two parts. We first detail in Embodiment 1 the proposed method to compute efficiently the Wasserstein barycenter of a set of N histograms. We follow in Embodiment 2 with the exposition of the method of the present invention to compute clustering where the weight distribution of each cluster is constrained to lie in a subset of the simplex.

### Embodiment 1

### Fast Computation of the Wasserstein Barycenter of N Histograms Given a Metric Between the Features, with Constraints on the Weights of that Barycenter

The method builds upon the following observation: given two histograms r in Σₙ and c in Σₘ, a cost matrix M with n lines and m columns, the original definition of the optimal transport distance (or Wasserstein distance) d_{M} between r and c:

$$\begin{matrix}{d}_{M} ( r , c ) = minimize & {\sum }_{i = 1 , j = 1}^{n , m} {m}_{ij} {t}_{ij} \\ subject to & {\sum }_{j = 1}^{m} {t}_{ij} = {r}_{i} , 1 \leq i \leq n \\ & {\sum }_{i = 1 ,}^{n} {t}_{ij} = {c}_{j} , 1 \leq j \leq m \\ & {t}_{ij} \geq 0 , i \leq n , j \leq m .\end{matrix}$$

can be computed using the dual formulation of that optimization, known as the dual optimal transport problem, which has exactly the same optimal value:

$$\begin{matrix}{d}_{M} ( r , c ) = maximize & {\sum }_{i = 1}^{n} {ρ}_{i} {r}_{i} + {\sum }_{j = 1}^{m} {γ}_{j} {c}_{j} \\ subject to & ρ ∈ {ℝ}^{n} , γ ∈ {ℝ}^{m} \\ & {ρ}_{i} + {γ}_{j} \leq {m}_{ij} , i \leq n , j \leq m . \\ & \end{matrix}$$

If we consider that c and M are fixed parameters, this dual expression shows explicitly that the transport distance between r and c is a convex, piecewise linear function of r. Additionally, it is known that the optimal dual vector ρ* which maximizes the expression above is a gradient of d_{M}(r,c) if the solution is unique, and a subgradient if that solution is not unique.

This formulation has an important practical consequence: for any histogram r, if we subtract a small positive fraction ε≈0 of the vector ρ* to r, and we make sure the resulting vector (r−ερ*) is still in Σₙ by projecting it back on Σₙ again (using a projection operator Pₙ) then we can guarantee that for ε small enough, Pₙ(r−ερ*) will be closer to c than r was originally, that is

d_{M}(Pₙ(r−ερ*),c)<d_{M}(r,c)

In summary, given c and M, we can find a histogram r such that d_{M}(r,c) is minimal using a (sub)gradient descent approach, simply by iterating the operation r←Pₙ(r−ερ*), taking for granted that ρ* is recomputed at each iteration. Consequently, the objective function we have defined to introduce the Wasserstein barycenter of a family {c¹, c², . . . , c^{N}} of N histograms,

$$\begin{matrix}{d}_{M} ( r , c ) = minimize & {\sum }_{i = 1 , j = 1}^{n , m} {m}_{ij} {t}_{ij} \\ subject to & {\sum }_{j = 1}^{m} {t}_{ij} = {r}_{i} , 1 \leq i \leq n \\ & {\sum }_{i = 1}^{n} {t}_{ij} = {c}_{j} , 1 \leq j \leq m \\ & {t}_{ij} \geq 0 , i \leq n , j \leq m .\end{matrix}$$

is also convex, piecewise linear, and can be minimized using a (sub)gradient descent algorithm which will simply carry out, at each iteration, the operation r←Pₙ(r−εΣᵢρᵢ*) where each ρᵢ* is the optimal dual variable obtained when computing d_{M}(r,c¹) with the dual optimal transport formulation.

This algorithm is very simple; it is, however, extremely costly to run in practice. This algorithm relies on the computation of N optimal dual variables at each step of the gradient descent: we need to compute a vector of optimal variables ρᵢ* for each histogram cⁱ in the dataset at each iteration of the gradient descent. Because, in the general case where the compared histograms r and cⁱ and the matrix M are arbitrary, the most efficient optimal transport solvers require a super-cubic number of operations O(n³log(n)), such an optimal dual variable can be extremely expensive to compute when the dimension n of the histograms is large.

To alleviate this problem we propose in this method to approximate the optimal dual transport problem using a smoothed formulation of the constraints that appear in the dual problem. Rather than require that m_{y}−ρᵢη≧≧0 for every pair of indices (i,j), we choose to add to the objective a steep negative penalty−exp(−λ(mᵢⱼij−ρᵢ+γⱼ)) which becomes rapidly very negative whenever the number λ>0 is very large.

$$\begin{matrix}{d}_{M}^{γ} ( r , c ) = maximize & {\sum }_{i = 1}^{n} {ρ}_{i} {r}_{i} + {\sum }_{j = 1}^{m} {γ}_{j} {c}_{j} - \\ & \frac{1}{λ} {\sum }_{i = 1 , j = 1}^{n , m} {e}^{- λ ( {m}_{ij} - {ρ}_{i} - {γ}_{j} )} \\ subject to & ρ ∈ {ℝ}^{n} , γ ∈ {ℝ}^{m} \end{matrix}$$

Solving the problem d^{λ}_{M}(r,c) is far more simple than solving the original problem d_{M}(r,c): one can show that the solution ρ*^{λ} to the smoothed problem can be recovered using the Sinkhorn matrix scaling algorithm. This method proposes thus to compute an approximate dual optimal solution and use it as such as a descent direction to modify the variable r at the current iteration before projecting it in the simplex Σₙ or a relevant subset Θ of Σₙ.

Since the Wasserstein barycenter algorithm of the present invention considers not only one distance, but a sum of N distances that need to be minimized, one of the essential contributions of the method according to the present invention is to provide, in Algorithm 2, an efficient way to compute the sum of all N approximate dual optimal solutions and store them in a variable ρ*^{λ}. By computing this sum of approximate dual optimal solutions, we can also show that we can recover, with the same algorithm and at no additional cost, a fast approximation to the sum of all primal optimal solutions of the transport problem. This will be, in turn, useful when using Algorithm 3.

Remark 1. An important aspect of Algorithm 2 is that this algorithm only involves linear algebra, and more precisely matrix-matrix product operations, as well as element-wise multiplications and inversions. The computations of Algorithm 2 can therefore be easily carried out on graphical processing units (GPU) and, as a result, can leverage the cheap computational power of graphics cards.

Remark 2. An important feature of Algorithm 1 is that it can be easily generalized to operate on histograms that do not have the same sum. A standard way to compare two probability measures that do not have the same sum with the transport metric is to create a virtual point ω in Ω which has a fixed distance Δ>0 to all other points in Ω, and add to the measure with the least sum a weight on ω equal to the absolute difference between their respective sums. We follow this idea to generalize our methods to that case.

In practice, this means that, when comparing two histograms r,c each of n bins but with a different total sum, using a metric matrix M of n columns and rows, this generalization would be realized by applying the following approach. Without loss of generality (by symmetry of the optimal transport distance), if we assume that the total sum of histogram r is less than the total sum of histogram c, the optimal transport distance from r to c parameterized by M is defined as the optimal transport distance between r′ and c parameterized by M′, where: (1 ) M′ is a matrix with n+1 rows and n columns, equal to the matrix M to which a constant row vector of length n uniformly equal to Δ has been appended at its bottom; (2) r′ is the histogram with a number of components equal to n+1, where the n first entries of r′ are equal to that of r, while the last entry is equal to the difference in the sum of the entries of c minus those of r. It is now easy to observe that, by definition of r′, r′ and share the same total sum. Using this definition, which applies for non-normalized histograms, it is now easy to use Algorithm 1 to compute the barycenter of N histograms that do not necessarily need to have the same sum, by replacing, whenever needed and at every step of the algorithm, any considered histogram by its normalized version, depending on the histogram to which it is compared against.

We provide a step-by-step presentation of our algorithm below:

Algorithm 1. Wasserstein Barycenter of N Histograms
1. Gather a dataset {c¹, c², . . . , c^{N}} histograms in the simplex Σₙ of n variables, and a matrix M with n columns and rows.
2. Define a relevant subset Θ of Σₙ along with a projector P_{Θ} onto that subset. A projector is a function which returns, given any vector γ, the closest point in Θ
3. Initialize r to the vector [1/n, 1/n, . . . , 1/n].
4. Repeat until desired convergence:
   a. Solve N dual problems {d^{λ}_{M}(r,c¹), d^{λ}_{M}(r,c²), . . . , d^{λ}_{M}(r,c^{N})} to recover N distances dᵢ and N dual optimal variables ρᵢ*^{λ} using the subroutine described below
   b. Form the approximate objective and approximate gradient using Algorithm 2.

$$objective = {\sum }_{i = 1}^{N} {d}_{i} , ρ = \frac{1}{N} {\sum }_{i = 1} {ρ}_{i}^{- λ}$$

c. Update the current variable r←P_{Θ}(r−ερ)
d. Stop if the absolute difference in objective between two successive iterations is below a predefined tolerance.

Algorithm 2. Computation of Aggregate Approximate Dual and Primal Optimal Variables
1. Store the dataset {c¹, c², . . . , c^{N}} of N histograms in the simplex Σₙ of n variables into a matrix C with n lines and N columns. Set a convergence tolerance TOL.
2. Compute the matrices K and Q with d lines and d columns, whose elements (i,j) are equal to kᵢⱼ=exp(−λmᵢⱼ); qᵢⱼ=mᵢⱼ exp(−λmᵢⱼ).
3. Initialize a matrix U with d lines and N columns, where each element of U is equal to 1/d.
4. Compute the matrix L=diag(L/r) K. Set z=infinity
5. Repeat until z<TOL is met:
   a. U=L/(L (C/(K′ U)))
   b. Every 10 iterations or so,
      i. Form V=C/(K′ U): U=L/(LV)
      ii. Update the exit condition z=∥V.*(K′U)−C)∥
6. Compute the aggregated approximate objective, aggregate dual optimum ρ*^{λ} and aggregate primal optimum T*^{λ}

$$\begin{matrix}{d}_{M}^{λ} ( r , c ) = maximize & {\sum }_{i = 1}^{n} {ρ}_{i} {r}_{i} + {\sum }_{j = 1}^{m} {γ}_{j} {c}_{j} - \\ & \frac{1}{λ} {\sum }_{i = 1 , j = 1}^{n , m} {e}^{- λ ( {m}_{ij} - {ρ}_{i} - {γ}_{j} )} \\ subject to & ρ ∈ {ℝ}^{n} , γ ∈ {ℝ}^{m} \end{matrix}$$

$${ρ}^{* λ} = {\frac{1}{λ} [ {{{\sum }_{j = 1}^{N} ( log ( {u}_{1 j} ) - log ( {u}_{ij} ) )}^{⋮}}_{⋮} ]}_{i}$$

$${T}^{* λ} = {[ {w}_{ij} {K}_{ij} ]}_{ij} where W = U {V}^{T}$$

### EXAMPLE 1

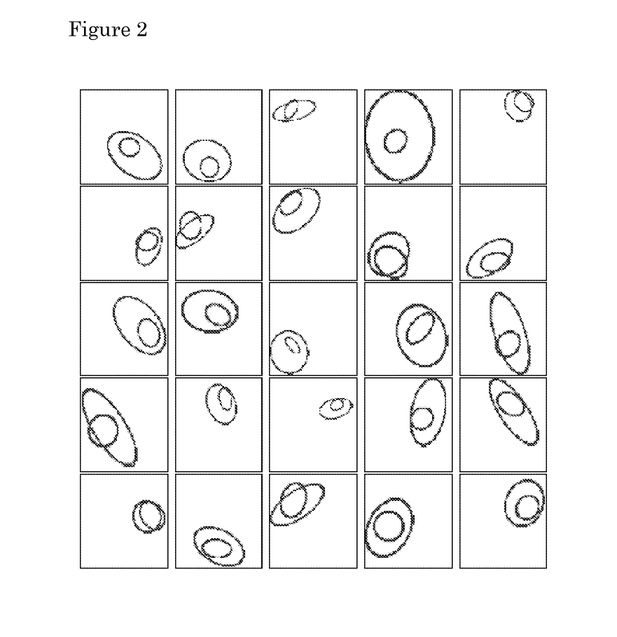

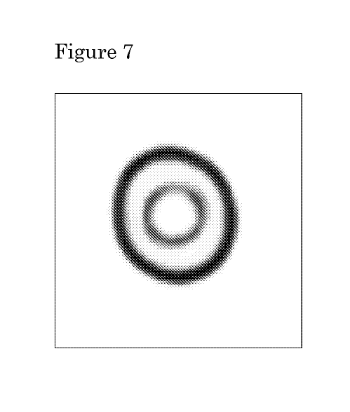

FIG. 7 is the mean for the 30 images of FIG. 2 using the metrics and preprocessing approaches of the present invention. Namely, FIG. 7 represents the optimal transport distance barycenter (or Wasserstein barycenter) using Algorithm 1.

### Embodiment 2

### Computation of k-Means Clustering of a Weighted Point Cloud with Constraints on the Weights of Each Cluster

The starting point of this method follows from the following observation: for a single set of points {x₁, x₂, . . . , xₙ}, where each point lies in Ω, the objective that is minimized in k-means can be equivalently rewritten in terms of the minimization of the Wasserstein distance between two weighted clouds of points.

$$\begin{matrix}{{min}_{( {y}_{1} , … , {y}_{k} ) ∈ {Ω}^{k}}}_{a ∈ {( 1 , … , k )}^{n}} \frac{1}{n} {\sum }_{i = 1}^{n} {dist ( {x}_{i} , {y}_{{n}_{i}} )}^{p} = {min}_{( {y}_{1} , … , {y}_{k} ) ∈ {Ω}^{k}} {min}_{a ∈ {( 1 , … , k )}^{n}} \frac{1}{n} {\sum }_{i = l}^{n} {dist ( {y}_{σ} , {x}_{i} )}^{p} \\ = {min}_{( {y}_{1} , … , {y}_{k} ) ∈ {Ω}^{k}} {min}_{a ∈ {Σ}_{k}} {W}_{p}^{p} ( {\sum }_{i = 1}^{k} {a}_{i} {δ}_{{y}_{i}} , \frac{1}{n} {\sum }_{i = 1}^{n} {δ}_{{x}_{i}} ) \\ = {min}_{( {y}_{1} , … , {y}_{k} ) ∈ {Ω}^{k}} {min}_{a ∈ {Σ}_{k}} {d}_{{M}_{Y N}^{p}} ( a , b )\end{matrix}$$

where above, the vector b is the uniform vector b=[1/n, . . . 1/n] Σₙ. The formulation on the right-hand side in the Equation above is still valid for non-uniform weights, and we consider the more general case where the points {x₁, x₂, . . . , xₙ} are weighted by an arbitrary vector b which is in the simplex Σₙ of n variables.

This reformulation shows that the k-means objective suggests to optimize both locations (y₁, . . . , yₖ) and the weights α of those locations. Although Lloyd's original algorithm does not consider any constraints on the values of α, and is therefore easier to implement than our approach here, we have just shown in Algorithm 1 that the restriction of the problem above to the optimization of α only, namely the computation of

$${min}_{a ∈ {Σ}_{k}} {d}_{{M}_{Y X}^{P}} ( a , b )$$

can be not only carried out when α is in the simplex, it can also be carried out when α is constrained to lie in any convex subset Θ of Σₖ for which we have an efficient projector P_{Θ}.

$${min}_{a ∈ Θ ⋐ {Σ}_{k}} {d}_{{M}_{Y X}^{P}} ( a , b )$$

using the approximate (sub)gradient descent method exposed in detail in Algorithm 1. Suppose now that, given α, b, X, which are considered here fixed, we wish to minimize that expression as a function of Y only. Suppose a current estimate for Y is available. Since, at the optimum, an optimal transport variable T* can be computed to provide the Wₚ Wasserstein distance, one can replace the expression above by the following expression,

$$f ( Y ) {=}^{def} {W}_{p}^{p} ( {\sum }_{i = 1}^{k} {a}_{i} {δ}_{{y}_{i}} , \frac{1}{N} {\sum }_{j = 1}^{N} {δ}_{{x}_{j}} ) = {\sum }_{ij} {t}_{ij}^{*} {dist ( {y}_{i} , {x}_{j} )}^{p}$$

where the second half of the equation is only valid because T* is an optimal transport.

If we assume, as we will do in the rest of this section, that Ω is the Euclidean space R^{d}, we can apply multivariate calculus on that expression to obtain that the derivative (gradient) of the objective ƒ with respect to each point yᵢ can be computed in a straightforward way by taking advantage of the knowledge of the distance function,

$$\frac{\partial f}{\partial {y}_{i}} = p {\sum }_{j} {t}_{ij}^{*} {dist ( {y}_{i} , {x}_{j} )}^{p - 1} ∇ dist ( {y}_{i} )$$

to form a gradient matrix ∇ of d lines (dimensionality) and k columns (each being given by the expression above) that can combine all of these individual gradients for each point yᵢ.

In summary, if we know the optimal transport T* relative to two points clouds, one of locations X and weights b, another of locations Y and weights α, as well as the gradient information of each of the distances dist(xᵢ, yᵢ) with respect to each yᵢ, we can update the matrix Y with a step ε small enough and the gradient ∇, Y←Y−ε∇, to ensure that ƒ(Y−ε∇)<ƒ(Y).
In the algorithm provided below, we assume for simplicity that the distance between two points is the Euclidean distance and that p=2, namely that for any two vectors u and

$$( u , v ) ∈ {ℝ}^{d} , {dist ( u , v )}^{2} = {‖ u - v ‖}_{2}^{2} = {( u - v )}^{T} ( u - v ) = {\sum }_{i = 1}^{d} {( {u}_{i} - {v}_{i} )}^{2}$$

This choice translates into simpler expressions and a simple algorithmic description. In particular, if one chooses this distance, one can obtain in closed form expression the minimum of the first order approximation of ƒ around Y, where one assumes that the optimal transport T* is the same for all Y. Elementary calculus shows that in that case this approximation of ƒ is a quadratic function of the matrix Y and the solution is X T*^{T} diag(b⁻¹), where diag(b⁻¹) is the diagonal matrix of size n whose diagonal coefficients are formed by the vector b⁻¹, that is the vector whose values are the inverse of each value of b.

Algorithm 3. Wasserstein Barycenter of Empirical Measures in R^{d} with weights constrained to be in a subset Θ of Σₖ
1. Gather a weighted cloud of points {x₁, x₂, . . . , xₙ} of n points in R^{d} with a weight vector b in the simplex Σₙ of n variables. These points can be represented as a matrix X of d lines and n columns.
2. Define a relevant subset Θ of Σₖ along with a projector P_{Θ} onto that subset. A projector is a function which returns, given any vector α, the closest point in Θ of that point.
3. Initialize Y to a d lines and k columns matrix. Each column might be sampled randomly among the columns of X. Set α to the vector [1/k, 1/k, . . . , 1/k].
4. Repeat until desired convergence:
   a. Form the distance matrix

M_{YX}=|∥yᵢ−xⱼ∥₂²|ᵢⱼ
b. Compute the optimal weights α using Algorithm 1 using M as a distance matrix parameter and b as the input histogram (N=1)
c. Compute the approximate optimal transport T*^{λ} using Algorithm 2.
d. Gradient step: Update Y←X T*^{T} diag(b⁻¹)

### EXAMPLE 2

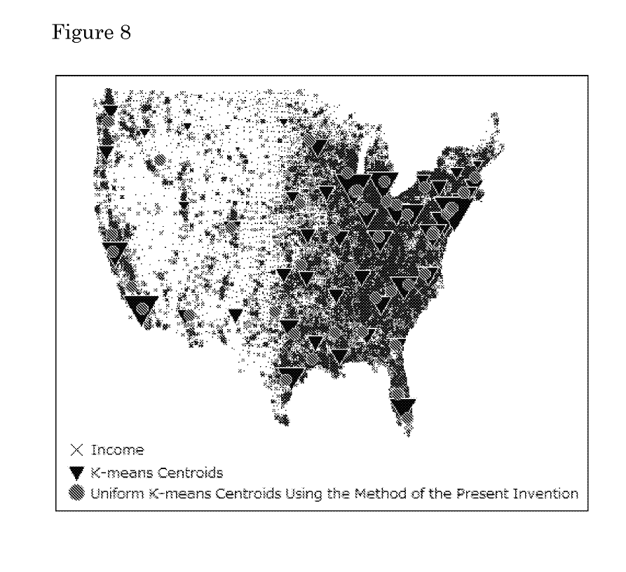

The algorithm of the present invention proposes to take into account explicit repartition constraints on the attribution vector and, if required, enforce an attribution that can have a desired smoothness. For instance, if we require that the mass of each cluster centroid is equal, the method of the present invention can obtain in FIG. 8 a clustering of US census data which is such that it minimizes the sum of residual errors taken for granted that each centroid captures a uniform share of the total income of the US represented in that map. In this example, Ω=R², the distance function is the Euclidean distance and p=2. Results of the clustering method of the present invention (i.e. algorithm 3) are depicted using discs, which imposes uniform weights for each centroid.

### INDUSTRIAL APPLICABILITY

We provide a list below of applications where the methods presented here have practical relevance.

### Applications to Clustering of Histogram Data (Algorithm 1)

The computation of Wasserstein barycenters (Algorithm 1) can be used to summarize a dataset of histograms when a metric between the features described in that histogram is given (the matrix M in the presentation of Algorithm 1is given). Consider for instance the following applications:
   1. A database of images is considered, each image is represented as a histogram of features (obtained using for instance SIFT features). Given a metric between these features, we can compute the mean histogram under the Wasserstein distance of those histograms.
   2. A database of texts is given. Using the bag-of-words representation of each text (namely, a histogram of words representation) and a suitable metric matrix between all the words in the dictionary, we can generate a unique mean histogram under the Wasserstein distance. This histogram will emphasize keywords that are common across all texts, and we expect it to be more sparse and informative than the naïve arithmetic mean, which is often used.
   3. A database of audio recordings is given. Using a dictionary extraction tool with that dataset, one can obtain a set of features that can efficiently characterize and describe each audio recording as a histogram of such features. Our algorithm can be used to obtain a mean recording in the optimal transport sense, and/or, be used as the intermediate centering step when carrying out k-means clustering.
   4. Consider a database of density patterns on a discretized manifold (population density on a map with irregular elevation, activations in the brain, activity in some nodes of a graph). Each point in the database can be interpreted as a histogram with as many bins as locations on that manifold. The manifold is not necessarily Euclidean: the distance between two nodes may not necessarily be computed as the Euclidean distance, but instead be a geodesic distance that takes into account local constraints (e.g. walking distance, taking into account elevation, between two points on a map with irregular relief, nodes on an incomplete yet connected graph with varying edge weights, in which case the distance can be computed as the result of the all pairs-shortest paths algorithm). Using Algorithm 1, we cab compute the average density pattern in the Wasserstein sense using the dataset that is available in addition to the metric matrix M, which describes the distance between all pairs of nodes in that graph.

Applications to Constrained Clustering Antenna-Relay Deployment with Capacity Constraints (Algorithm 2)
Suppose we are given a population irregularly distributed in a Euclidean space, with a distance function D(x,y) that admits a subgradient at each point x. In practice, the standard k-means cost function applied to that population could be minimized with a set of centroids X and weight vector α such that the entropy of α is very small. In layman terms, most of the original items in the dataset could be attributed to a small subset <<k of centroids while all of the other centroids would capture a very small amount of the total population.

This could be undesirable in applications of k-means where a more regular attribution is sought. For instance, in sensor deployment, when each centroid (sensor) is limited in the number of data points (users) it can serve, we would like to ensure that the attributions agree with those limits. Whereas the original k-means cannot take into account such limits, we can ensure them using Algorithm 2 and setting for Θ the set of histograms in Σ_{λ} which have entropy larger than a threshold of log(k)−α, where α≧0 defines the entropy threshold. In that case, the projection of a non-negative vector on that set using the Kullback-Leibler divergence can be trivially implemented as finding the exponent t such that the entropy of ū in Σₖ defined component-wise as

$${\tilde{u}}_{i} = {( {u}_{i} )}^{t} / {\sum }_{i = 1}^{k} {( {u}_{i} )}^{t}$$

is equal to log(k)−α. In the case where α=0 note that in that case the set Θ reduces to the uniform histogram of weights 1/k.

1. A method that relies on approximating the solution of any optimization problem that involves optimal transport distances, using, instead of each of these distances, a numerical approximation of the optimal transport distance that incorporates an entropic smoothing term of weight 1/λ, λ being a positive number.

2. A method to compute approximate dual and primal optimal variables, comprising:
a step of storing the dataset {c¹, c², . . . , c^{N}} of N histograms in the simple Σₙ of n variables into a matrix C with n lines and N columns, and setting a convergence tolerance TOL;
a step of computing the matrices K and Q with d lines and d columns, whose elements (i,j) are equal to kᵢⱼ=exp(−λ mᵢⱼ); qᵢⱼ=mᵢⱼ exp(−λ mᵢⱼ);
a step of initializing a matrix U with d lines and N columns, where each element of U is equal to 1/d;
a step of computing the matrix L=diag(L/r) K. Set z=infinity;
a step of repeating a) and b) until z<TOL is met:
a) U=L/(L (C/(K′U)))
b) every predetermined number of iterations,
i. forming V=C/(K′ U); U=L/(LV)
ii. updating the exit condition z=∥V.*(K′U)−C)∥; and
a step of computing the aggregated approximate objective, aggregating dual optimum ρ*^{λ} and aggregating primal optimum T*^{λ}
$$\begin{matrix}{d}_{M}^{λ} ( r , c ) = maximize & {\sum }_{i = 1}^{n} {ρ}_{i} {r}_{i} + {\sum }_{j = 1}^{m} {γ}_{j} {c}_{j} - \\ & \frac{1}{λ} {\sum }_{i = 1 , j = 1}^{n , m} {e}^{- λ ( {m}_{ij} - {ρ}_{i} - {γ}_{j} )} \\ subject to & ρ ∈ {ℝ}^{n} , γ ∈ {ℝ}^{m} \end{matrix}$$
$${ρ}^{* λ} = {\frac{1}{λ} [ {{{\sum }_{j = 1}^{N} ( log ( {u}_{1 j} ) - log ( {u}_{ij} ) )}^{⋮}}_{⋮} ]}_{i}$$
$${T}^{* λ} = {[ {w}_{ij} {K}_{ij} ]}_{ij} where W = U {V}^{T}$$

3. A method to compute Wasserstein barycenters of N histograms, comprising:
a step of gathering a dataset {c¹, c², . . . , c^{N}} of N histograms in the simplex Σₙ of n variables, and a matrix M with n columns and rows;
a step of defining a relevant subset Θ of Σₙ along with a projector P_{Θ} onto that subset where a projector is a function which returns, given any vector y, the closest point in Θ;
a step of initializing r to the vector [1/n, . . . , 1/n]; and
a step of repeating c) to f) until desired convergence;
c) solving N dual problems {d^{λ}_{M}(r,c¹), d^{λ}_{M}(r,c²), . . . , d^{λ}_{M}(r,c^{N})} to recover N distances dᵢ and N dual optimal variables ρᵢ*^{λ} using the subroutine described below,
d) forming the approximate objective and approximate gradient using the method of claim 1,
$$objective = {\sum }_{i = 1}^{N} {d}_{i} , ρ = \frac{1}{N} {\sum }_{i = 1} {ρ}_{i}^{- λ}$$
e) updating the current variable r←P_{Θ}(r−ερ), and
f) stopping if the absolute difference in objective between two successive iterations is below a predefined tolerance.

4. A method to compute Wasserstein barycenters of empirical measures in R^{d} with weights constrained to be in a subset Θ of Σₖ, comprising:
gathering a weighted cloud of points {x₁, x₂, . . . , xₙ} of n points in R^{d} with a weight vector b in the simplex Σₙ of n variables, where the points can be represented as a matrix X of d lines and n columns:
defining a relevant subset Θ of Σₖ along with a projector P_{Θ}onto that subset, where the projector is a function which returns, given any vector α, the closest point in Θ of that point;
initializing Y to a d lines and k columns matrix, where each column might be sampled randomly among the columns of X;
setting α to the vector [1/k, 1/k, . . . , 1k]; and
repeating g) to j) until desired convergence;
g) forming the distance matrix
M_{YX}=|∥yᵢ−xⱼ∥₂²|ᵢⱼ
h) computing the optimal weights α using Algorithm 1 using M as a distance matrix parameter and b as the input histogram (N=1).
i) computing the approximate optimal transport T*^{λ} using the method of claim 1, and
j) updating Y←X T*¹ diag(b⁻¹).
